(19) United States
(12) Patent Application Publication
(10) Pub. No.: US 2024/0330045 A1
(43) Pub. Date: Oct. 3, 2024

(54) INPUT LOCALITY-ADAPTIVE KERNEL CO-SCHEDULING

(71) Applicant: Advanced Micro Devices, Inc., Santa Clara, CA (US)

(72) Inventors: William Peter Ehrett, Austin, TX (US); Vinay Bharadwaj Ramakrishnaiah, Bellevue, WA (US); Bradford M. Beckmann, Bellevue, WA (US)

(73) Assignee: Advanced Micro Devices, Inc., Santa Clara, CA (US)

(21) Appl. No.: 18/194,001

(22) Filed: Mar. 31, 2023

(51) Int. Cl. G06F 9/48; G06F 9/38

(52) U.S. Cl. CPC G06F 9/4881; G06F 9/3885

(57) ABSTRACT

A technique for scheduling executing items on a highly parallel processing architecture is provided. The technique includes identifying a plurality of execution items that share data, as indicated by having matching commonality metadata; identifying an execution unit for executing the plurality of execution items together; and scheduling the plurality of execution items for execution together on the execution unit.

### BACKGROUND

Graphics processing units and similar hardware have an extreme degree of parallelism. The complexity inherent in such devices means that there are large opportunities for optimization in the execution of workloads on such devices.

### BRIEF DESCRIPTION OF THE DRAWINGS

A more detailed understanding may be had from the following description, given by way of example in conjunction with the accompanying drawings wherein:

FIG. 1 is a block diagram of an example device in which one or more features of the disclosure can be implemented;

FIG. 2 is a block diagram of the device, illustrating additional details related to execution of processing tasks on the accelerated processing device of FIG. 1, according to an example;

FIG. 3 is a diagram illustrating inputs and outputs for two different execution items, according to an example;

FIG. 4 illustrates aspects of scheduling such execution items together, according to an example;

FIG. 5 illustrates additional details related to the system of FIG. 4, according to an example; and

FIG. 6 is a flow diagram of a method for scheduling execution items, according to an example.

### DETAILED DESCRIPTION

A technique for scheduling executing items on a highly parallel processing architecture is provided. The technique includes identifying a plurality of execution items that share data, as indicated by having matching commonality metadata; identifying an execution unit for executing the plurality of execution items together; and scheduling the plurality of execution items for execution together on the execution unit.

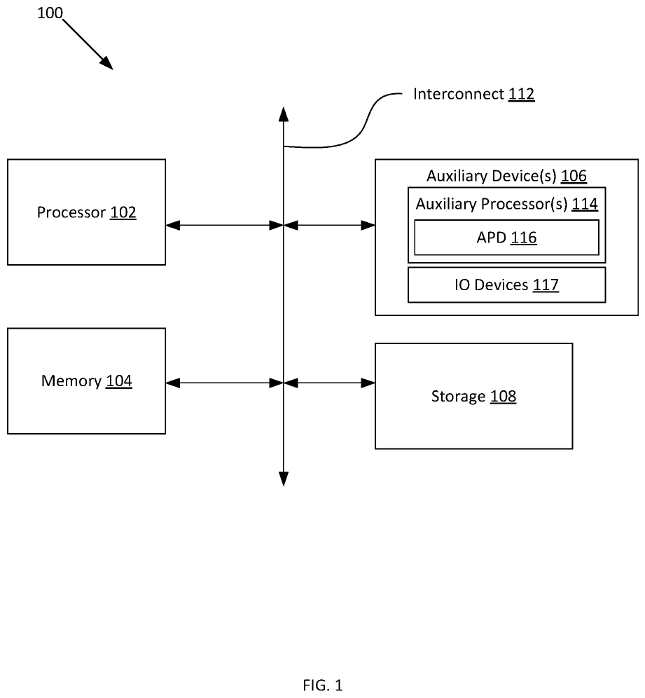

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, a network, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary processors 114 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

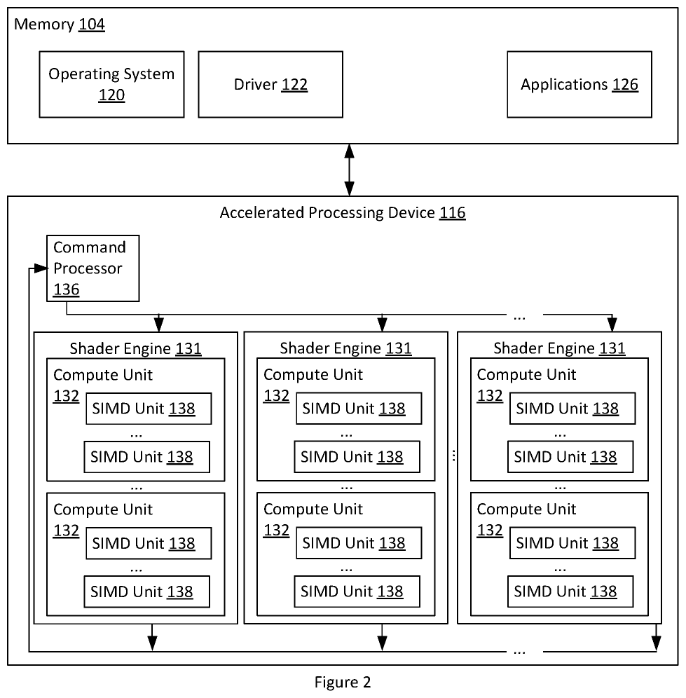

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some implementations, the driver 122 includes a just-in-time compiler that compiles programs for execution by processing components (such as the SIMD units 138 discussed in further detail below) of the APD 116. In other implementations, no just-in-time compiler is used to compile the programs, and a normal application compiler compiles shader programs for execution on the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 (together, parallel processing units 202) that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache. In some examples, the compute units 132 are organized into shader engines 131. The shader engines 131 contain shader engine resources (e.g., memory) available to components of the shader engines 131 but not necessarily available to any elements external to the shader engines 131. The compute units 132 include compute unit resources (e.g., memory) available to components of the compute units 132 but not necessarily available to any element external to the compute units 132.

The basic unit of execution in compute units 132 is a work-item. Each work-item represents a single instantiation of a program that is to be executed in parallel in a particular lane. Work-items are executed simultaneously as a “wavefront” on a single SIMD processing unit 138. One or more wavefronts are included in a “work group,” which includes a collection of work-items designated to execute the same program. A work group is executed by executing each of the wavefronts that make up the work group. In alternatives, the wavefronts are executed sequentially on a single SIMD unit 138 or partially or fully in parallel in the same or different SIMD units 138. A command processor 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus, in some instances, a graphics processing pipeline, which accepts graphics processing commands from the processor 102, provides computation tasks to the compute units 132 for execution in parallel. In some examples, however, a graphics processing pipeline is not present in the APD 116.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

As described above, the APD 116 is capable of executing compute shader programs. Herein, the term “kernel” has the same meaning as “compute shader program.” The APD 116 is capable of executing many different types of shader programs concurrently. However, there is significant opportunity for performance improvement related to the reuse of resources. Additional details are provided below.

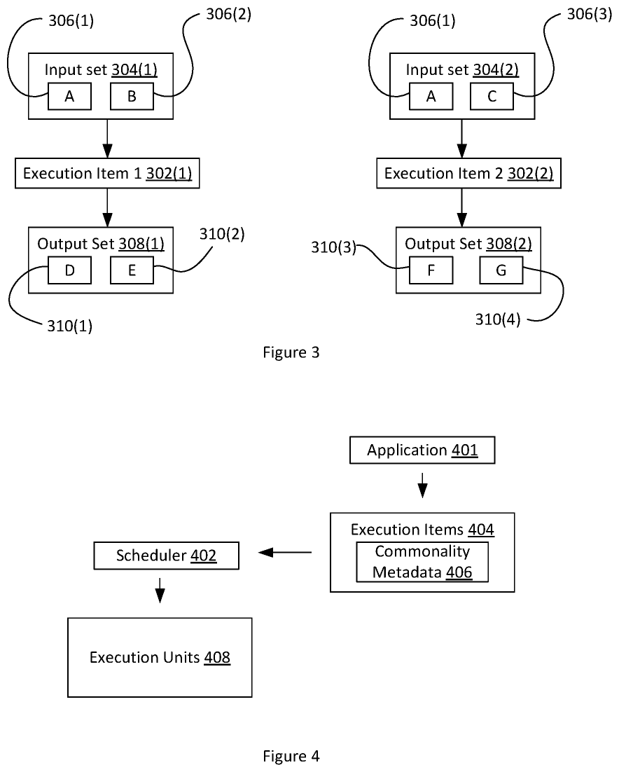

FIG. 3 is a diagram illustrating inputs and outputs for two different execution items 302, according to an example. In some examples, an execution item 404 is a kernel, a workgroup, or a wavefront. In some examples, an execution item is an element of execution different than a kernel, a workgroup, or a wavefront. A first execution item 302(1) and a second execution item 302(2) are shown. In some examples, these two execution items 302 are or originate from instances of invocation of different shader programs. In some examples, the two execution items 302 are or originate from different invocations of the same shader program (same compute shader program).

Each execution item 302 has an input set 304. The input set 304 is the data read in by the execution item 302. Each execution item 302 also has an output set 308 which is the data output by the execution item 302. For execution item 1 302(1), the input set 304(1) includes input item A 306(1) and input item B 306(2) and the output set 308(1) includes output item D 310(1) and output item E 310(2). For execution item 2 302(2), the input set 304(2) includes input item A 306(1) and input item C 306(3) and the output set 308(2) includes output item F 310(3) and output item G 310(4). Each item of data has a particular address and a range. The address specifies the location (such as within memory of the APD 116 or in system memory 104) of the item data and the range specifies the amount of data at that range. In some cases, the input set and output set of an execution item overlap; that is, in some examples, some data is read and updated rather than strictly read or written.

As can be seen, both execution item 1 302(1) and execution item 2 302(2) include input item A 306(1) in their input set 304. Thus, both execution item 1 302(1) and execution item 2 302(2) read from the same memory addresses. This commonality in access to input data items presents an opportunity for optimization. Specifically, if execution items 302 that read the same input data items 306 were intentionally scheduled “together,” then the memory-related performance utilized for such reads can be improved as compared with a scenario in which no regard is given to scheduling such execution items 302 “together.” Such benefits can also be gained for items other than inputs (such as outputs).

For this reason, techniques are provided herein for scheduling execution items that share resources (e.g., input items 306) “together.” FIG. 4 illustrates aspects of scheduling such execution items together, according to an example. An application 401 specifies execution items 404 as well as commonality metadata 406 for the execution items. This commonality metadata 406 may be generated in various ways: without loss of generality, it may be manually specified by a programmer, it may be determined by the compiler, or it may be automatically generated at run-time (for instance, via just-in-time compilation techniques as dynamic data structures are resolved). A scheduler 402 examines the execution items 404 including commonality metadata 406 and schedules the execution items 404 on the execution units 408 based on the commonality metadata 406. Specifically, the commonality metadata 406 includes information about which resources (e.g., inputs) are shared between execution items 404. The scheduler 402 schedules execution items 404 that share resources “together,” to improve performance (for example by improving cache performance). For example, the scheduler 402 schedules different kernel that share an input to execute within the same shader engine 131, so that accesses to inputs from both kernels can be made within the same time period, improving performance as compared with a situation in which such kernels were scheduled in different shader engines 131 and/or at different times, which could result in eviction of commonly used cache lines from cache or other resources.

It is possible for the commonality metadata 406 to specify commonality between different types of execution items 404. In various examples, different types of execution items 404 include a kernel instance, a workgroup, or a wavefront. Thus, the commonality metadata 406 is capable of specifying, in one or more implementations or modes of execution, that different instances of kernel execution should be executed together, that different workgroups of the same or different kernel executions should be executed together, or that different wavefronts of the same or different kernel executions should be executed together. A kernel execution or kernel invocation is an instance of execution of a kernel with a given set of parameters (e.g., number of work-items, set of inputs, output location, or the like).

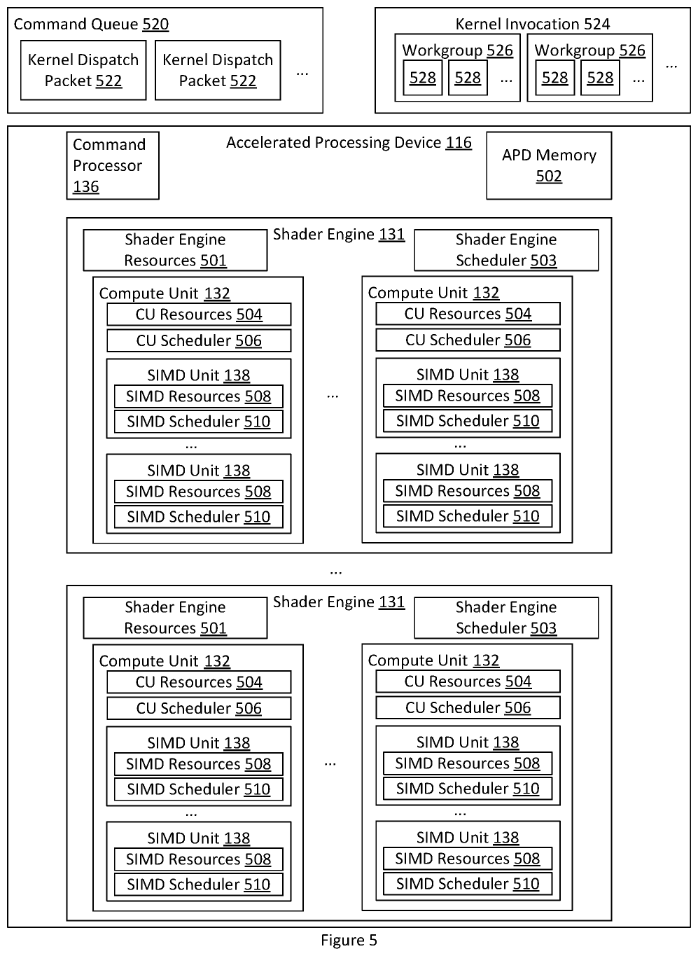

FIG. 5 illustrates additional details related to the system of FIG. 4, according to an example. An application (e.g., application 126 of FIG. 2) writes kernel dispatch packets 522 into a command queue 520. A kernel dispatch packet 522 specifies a compute shader program to execute, a size (e.g., number of work-items), inputs and outputs, and other parameters. An instance of execution of a kernel dispatch packet 522 is a kernel invocation 524, which executes within the APD 116. A kernel invocation 524 is executed as one or more workgroups 526 and each workgroup 526 is executed as one or more wavefronts 528.

In some examples, a workgroup 526 is constrained to a particular execution unit, such as a compute unit 132. In other words, in such examples, all wavefronts 528 of a workgroup 526 execute within the same compute unit 132. In addition, in some examples, a wavefront 528 is constrained to a particular execution unit such as a SIMD unit 138. In other words, in such examples, a wavefront 528 executes entirely within a single SIMD unit 138 and not within any other SIMD unit 138.

In some examples, a kernel invocation 524 executes entirely within a shader engine 131, meaning that all workgroups 526 for the kernel invocation 524 execute within a single shader engine 131 and no workgroups 526 for the kernel invocation 524 execute within different shader engines 131 as each other.

The command processor 136 of the accelerated processing device 116 obtains kernel dispatch packets 522 from the command queue 520 and triggers execution of kernel invocations within the APD 116 accordingly. For example, the command processor 136 causes a plurality of workgroups 526 to execute in a particular shader engine 131.

The shader engines 131, compute units 132, and SIMD units 138 have respective resources and schedulers. In general, the resources include memory local to the particular unit and the schedulers include circuitry configured to schedule execution of a particular type of execution item 404. In some examples, shader engine resources 501 include memory that is considered local to a particular shader engine 131 (e.g., the shader engine 131 in which the shade engine resources 501 are located). In some examples, compute unit resources 504 include memory that is considered local to a particular compute unit 132 and SIMD resources 508 include memory that is considered local to a particular SIMD unit 138. In some examples, memory that is local to a hardware unit is memory that can be directly accessed (e.g., read from or written to) by execution items 404 executing within that hardware unit but that cannot be directly accessed by other execution items 404. In some examples, memory being able to be “directly accessed” by an execution item means that the execution item is able to read from or write to that memory by address or name.

In addition to the above, in some examples, each “level” of execution unit includes a scheduler. For example, each shader engine 131 includes a shader engine scheduler 503, each compute unit 132 includes a compute unit scheduler 506, and each SIMD unit 138 includes a SIMD scheduler 510. The schedulers schedule a respectively type of execution item 404 within the corresponding execution units 132. In an example, a shader engine scheduler 503 assigns workgroups to the compute units 132. In an example, a compute unit scheduler 506 assigns wavefronts to individual SIMD units 138, and SIMD scheduler 510 schedules execution of wavefronts within the corresponding SIMD unit 138.

As described above, commonality metadata 406 specifies data items that are shared between execution items 404. Scheduling execution items with such commonalities together allows the shared data items to be located in the same memory. For example, if two different wavefronts from two different kernel invocations 524 are scheduled to execute together in the same SIMD unit 138, then the shared input value can be stored in a single SIMD unit 138 (e.g., in SIMD resources 508 of a single SIMD unit 138), resulting in a performance increase as described herein. For this reason, in response to commonality metadata 406 indicating that commonality exists between execution items 404, a scheduler 402 schedules the execution items 404 together. The scheduler 402 may be any one of the command processor 136, the shader engine scheduler 503, the CU scheduler 506, or the SIMD scheduler 510, or may be software executing in the APD 116 or on the processor 102 (such as, e.g., the driver 122). An execution item 404 may be one of a kernel invocation 524, a workgroup 526, or a wavefront 528.

In some examples, the commonality metadata 406 includes one or more of the following items of information: common data identifiers and an execution item type for which co-scheduling is to occur. The common data identifiers identify one or more items of data referenced by a kernel. In some examples, such items of data are inputs to the kernel. The execution item type for which co-scheduling is to occur is the type of execution item for which co-scheduling is to occur. As described elsewhere herein, scheduling execution items together can occur for kernel invocations 524, workgroups 526, or wavefronts 528. The execution item type portion of the commonality metadata 406 specifies which execution item type co-scheduling is to occur for.

In summary, the commonality metadata 406 includes hints that indicate to a scheduler 402 which execution items 404 are to be scheduled together (also referred to as “co-scheduling”). In greater detail, a scheduler 402 receives information about multiple execution items, including the commonality metadata 406. In the event that the commonality metadata 406 indicates that at least two of such execution items should be scheduled together, the scheduler 402 schedules those items together.

It should be understood that the scheduler 402 is not always able to schedule execution items together in the event that the execution items have commonality metadata 406 indicating that such execution items are to be scheduled together. In various examples, there are more such execution items ready to be scheduled together than can actually be scheduled on the hardware. In such examples, the scheduler 402 selects a subset of execution items to be scheduled together from a larger set of items that commonality metadata 406 indicates can be scheduled together. In various examples, the commonality metadata 406 includes degrees or patterns of data sharing such as similarity metrics, optimal locations of data in a data hierarchy, or other items. In some such examples, the scheduler 402 determines which execution items to scheduler together by considering such degrees, similarity metrics, or patterns of data sharing. In some examples, where there is a relatively large number of execution items eligible for being scheduled together, the scheduler 402 selects execution items to be scheduled together that result in more optimal performance. In some examples, more optimal performance is gained where data that is shared between execution items is located in a single portion of memory that is shared between multiple execution items, rather than being duplicated in different portions of memory. In some examples, the scheduler 402 makes trade-offs in scheduling the execution items, by selectively co-scheduling execution items together based on the degrees or patterns of data sharing. More specifically, in some such examples, the scheduler 402 prioritizes scheduling execution items with a greater degree of data sharing together. In some examples, such prioritization means that where the scheduler 402 is presented with multiple execution items that are eligible to be scheduled together based on the commonality metadata 406, and there are insufficient system resources to schedule all such execution items together, the scheduler 402 selects the execution items having a greater degree of data sharing for scheduling together, allowing the other execution items to be scheduled at a later time, on different hardware, or both. In various examples, the similarity metrics, or patterns of data sharing are specified manually (e.g., by an application that requests performance of the execution items) or automatically (e.g., by software such as the driver 122 or hardware such as the scheduler 402). In some examples, the automatic determination of a similar metric is performed in the following manner. In one example, the scheduler 402 or other entity calculates a cosine similar metric between feature vectors based on characteristics of the execution items involved. In some examples, the elements of the feature vectors represent a different location of data in the memory hierarchy, weighted proportional to the proximity of the data to the core. In some examples, such values could include data from hardware counters that characterize kernels.

In some examples, the scheduler 402 is at least partially software that, in part, decouples the queues exposed to the application from the queues mapped to the hardware queue descriptors. More specifically, applications submit work for execution by a processor such as the APD 116 by writing queue entries into a software command queue. Subsequently, an element such as the driver 122 writes the queue entries from the software command queue into hardware command queues. The processor reads these hardware command queues to obtain the entries and performs work (e.g., executes kernel invocations) based on these queues. In some examples, the scheduler 402 is interposed between the application and the software command queue. When an application submits work into a queue for execution, the scheduler 402 reads such queues and groups entries together that have commonality metadata 406 indicating such entries should be executed together. The scheduler 402 submits these reorganized queues to the hardware (e.g., APD 116) for executing. In other words, the scheduler 402 determines whether execution items should be scheduled together as described elsewhere herein (e.g., according to the commonality metadata 406) and reorganizes the command queue such that execution items that should be scheduled together are located close together in the reorganized queue. By placing these items close together, the processor is more likely to schedule these items together.

In other examples, the scheduler 402 is part of the processor, such as the APD 116. In such examples, the scheduler 402 is one or more schedulers in the APD 116. In some examples, the scheduler 402 is one or more of the schedulers illustrated in FIG. 5 and operates as described elsewhere herein.

In some examples, the commonality metadata 406 includes an identifier (a “commonality identifier”). Execution items that share the same identifier are eligible for co-scheduling and execution items that do not share the same identifier are not eligible for co-scheduling. In other examples, the commonality metadata 406 includes an identifier for each data item referenced by the execution item 404. In such examples, execution items that share the same identifier for at least one data item are eligible for co-scheduling.

In some examples, in response to two execution items 404 being eligible for co-scheduling, the scheduler 402 schedules such execution items 404 together. In examples where the commonality metadata 406 includes an indication of an execution item type, the scheduler 402 schedules execution items of that type together.

Additional detail regarding scheduling related to execution item type specified by the commonality metadata 406 is now provided. In general, if such information is provided, such information specifies a type of execution items, such as a kernel invocation 524, a workgroup 526, or a wavefront 528. In some examples, each execution item type is associated with a type of an execution unit 408. In an example, a wavefront 528 is associated with a SIMD unit 138, a workgroup 526 is associated with a compute unit 132, and a kernel invocation 524 is associated with a shader engine 131. Scheduling execution items of a particular type together includes scheduling such execution items to execute together in the execution unit 408 associated with that execution item type. In an example, where the execution item type for two kernel dispatch packets 522 that are eligible for co-scheduling is wavefront, a scheduler 402 schedules wavefronts of those two kernel dispatch packets 522 for execution in the same SIMD unit 138. In another example, where the execution item type is workgroup, the scheduler 402 co-schedules two workgroups for execution in the same compute unit 132. In yet another example, where the execution item type is kernel invocation, the scheduler 402 co-schedules two kernel invocations on the same shader engine 131. In various examples, the scheduler 402 includes one or more of the command processor 136, the shader engine scheduler 503, the CU scheduler 506, or the SIMD scheduler 510.

Scheduling execution items together means scheduling the execution items to execute on the same hardware unit and/or within the same time period. Scheduling execution items to execute on the same hardware means scheduling the execution items 302 for execution within the same hardware unit of the APD 116. In some examples, such a hardware unit is a shader engine 131 or a compute unit 132. In other words, in some examples, scheduling execution items to execute on the same hardware means scheduling the execution items 302 for execution within the same compute unit 132. In other examples, scheduling execution items to execute on the same hardware means scheduling the execution items 302 for execution within the same shader engine 131.

In some examples, scheduling the execution items to execute within the same time period includes scheduling the execution items such that at least one instruction in each execution item executes in the same clock cycle. In other words, the SIMD unit 138 are clocked by a clock. Instruction execution is timed by this clock, with each instant of time or “tick” of the clock being a clock cycle. In some examples, scheduling the execution items to execute within the same time period means that for at least one clock cycle, at least one instruction of each execution item executes on that clock cycle, resulting in the execution items “overlapping” at least partially in time.

In some examples, scheduling the execution items to execute within the same time period includes scheduling the execution items such that at least one memory access for each execution item results in an access to the same cache line without that cache line being evicted from a particular cache. In some such examples, it is not necessary for both such execution items to have any instructions that execute at the same time. In other words, in some such examples, it is not necessary for the two execution items to execute in an overlapping time period. Instead, in such examples, the two execution items execute sufficiently closely in time that memory accesses that result in particular data being brought into a relevant cache stays in that cache and is not evicted while both execution items are executed. Avoiding eviction of such cache lines avoids the associated memory and cache traffic associated with eviction (e.g., write-back) as well as with reading such cache lines back into the cache.

In some examples, scheduling the execution items to execute within the same time period means that the execution items are scheduled such that at least one instruction of each execution item executes a threshold amount of real time or clock time within each other. In other words, in these examples, at least a portion of each execution item executes within a threshold amount of time of each other. For example, if the threshold amount of time is 1,000 clock cycles, then at least one instruction of each execution item must execute within a 1,000 clock cycle window. Put differently, the end of one execution item must be at least 1,000 clock cycles from the beginning of the other execution item.

In some examples, scheduling the execution items to execute within the same time period means alternating execution item execution such that the data read into the caches is not evicted. In other words, in such examples, the execution items “take turns” executing. Due to repeatedly accessing the same cache line, the cache line is not evicted. Even though the execution items do not execute in overlapping time periods, executing the execution items close together in time provides cache performance benefits.

In some examples, a scheduler 402 determines which items to schedule together by examining the execution items at the heads of hardware queues that store execution items available for execution. In some examples, the scheduler 402 determines which items to schedule together by examining the execution items at the heads and further into the queues. In some examples, after examining the items at the heads and further into the queues, the scheduler 402 reorders the items in the queues according to the rest of the disclosure herein (e.g., in order to cause specific execution items to execute together as described elsewhere herein). In some examples, this reordering respects dependency barriers. In some examples, a scheduler 402 pre-empts already-dispatched work, causing such work to pause so that other execution items are scheduled together prior to resumption of the pre-empted work.

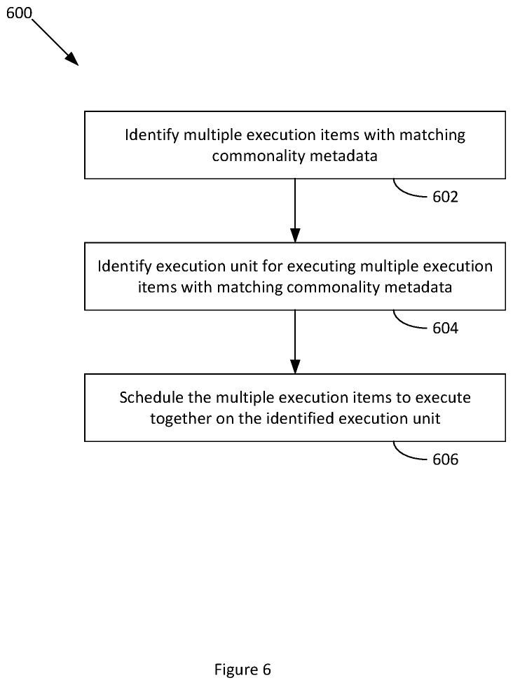

FIG. 6 is a flow diagram of a method 600 for scheduling execution items, according to an example. Although described with respect to the system of FIGS. 1-5, those of skill in the art will understand that any system, configured to perform the steps of the method 600 in any technically feasible order, falls within the scope of the present disclosure.

At step 602, a scheduler 402 identifies multiple execution items 404 with matching commonality metadata 406. As described above, in some examples, an execution item 404 includes one of a kernel invocation 524, a workgroup 526, or a wavefront 528. In some examples, commonality metadata 406 matches in the event that the commonality metadata 406 for two such execution items 404 includes the same commonality identifier. In one such example, the commonality metadata 406 indicates that the two execution items 404 use the same input data item. In another such example, the commonality identifier of the commonality metadata 406 for both such execution items 404 is the same, which is an indication that at least some of the data (e.g., some of the input data) used by both execution items 404 is the same.

At step 604, the scheduler 402 identifies an execution unit for executing the multiple execution items identified in step 602. In some examples, the identified execution unit is a single execution unit, in which to execute both execution items 404 together. In some examples, the execution unit is one of an APD 116, a shader engine 131, a compute unit 132, or a SIMD unit 138. In some examples, the type execution unit that is identified is based on the execution item type specified in the commonality metadata 406. In an example, kernel invocations 524 are scheduled in the same shader engine 131, workgroups 526 are scheduled in the same compute unit 132, and wavefronts 528 are scheduled in the same SIMD unit 138. In some examples, scheduling execution items on the same hardware unit means that the execution items execute on that hardware unit and not on another hardware unit of the same type.

At step 606, the scheduler 402 schedules the identified multiple execution items to execute together on the identified execution unit. As described elsewhere herein, executing together includes executing within a common time period and on the same execution unit.

The processor 102 and APD 116 are hardware circuits configured to process instructions and data. The memory 104, storage 108, APD memory 502, shader engine memory, compute unit memory, and SIMD unit memory are data storage circuits configured to store data for access. The command processor 136, shader engines 131, compute units 132, SIMD units 138, shader engine scheduler 503, CU scheduler 506, and SIMD scheduler 510 are hardware (e.g., hardware circuitry such as a processor configured to execute instructions). Any of the auxiliary devices 106 is implemented as hardware (e.g., circuitry), software, or a combination thereof. Any other unit not mentioned is implemented as hardware (e.g., circuitry) such as a processor of any technically feasible type, software executing on a processor, or a combination thereof, as would be technically feasible.

It should be understood that many variations are possible based on the disclosure herein. In an example, rather than being performed on the described APD 116, the techniques described herein are performed on a processor that is not part of an APD 116 and/or that does not have single-instruction-multiple-data capabilities. Although features and elements are described above in particular combinations, each feature or element can be used alone without the other features and elements or in various combinations with or without other features and elements.

The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method, comprising:
identifying a plurality of execution items that share data, as indicated by having matching commonality metadata;
identifying an execution unit for executing the plurality of execution items together; and
scheduling the plurality of execution items for execution together on the execution unit.

2. The method of claim 1, wherein the plurality of execution items includes a first execution item having first commonality metadata and a second execution item having second commonality metadata.

3. The method of claim 2, wherein identifying the plurality of execution items having matching commonality metadata includes identifying that a first commonality indicator of the first commonality metadata is significantly similar to a second commonality indicator of the second commonality metadata.

4. The method of claim 2, wherein identifying the execution unit comprises identifying the execution unit based on the first commonality metadata and the second commonality metadata.

5. The method of claim 4, wherein the first commonality metadata and the second commonality metadata include an execution item type identifier.

6. The method of claim 5, wherein identifying the execution unit comprises identifying the execution unit as an execution unit that correlates to the execution item type of the execution item type identifier.

7. The method of claim 1, wherein scheduling the plurality of execution items for execution together comprises scheduling the plurality of execution items to execute in a first time period.

8. The method of claim 7, wherein scheduling the plurality of execution items to execute in the first time period includes scheduling the plurality of execution items to each execute at least partially at the same time.

9. The method of claim 7, wherein scheduling the plurality of execution items to execute in the first time period includes scheduling the plurality of execution items to execute within a threshold amount of time.

10. A device, comprising:
a processor; and
a scheduler configured to:
identify a plurality of execution items that share data, as indicated by having matching commonality metadata;
identify an execution unit of the processor for executing the plurality of execution items together; and
schedule the plurality of execution items for execution together on the execution unit.

11. The device of claim 10, wherein the plurality of execution items includes a first execution item having first commonality metadata and a second execution item having second commonality metadata.

12. The device of claim 11, wherein identifying the plurality of execution items having matching commonality metadata includes identifying that a first commonality indicator of the first commonality metadata is significantly similar to a second commonality indicator of the second commonality metadata.

13. The device of claim 11, wherein identifying the execution unit comprises identifying the execution unit based on the first commonality metadata and the second commonality metadata.

14. The device of claim 13, wherein the first commonality metadata and the second commonality metadata include an execution item type identifier.

15. The device of claim 14, wherein identifying the execution unit comprises identifying the execution unit as an execution unit that correlates to the execution item type of the execution item type identifier.

16. The device of claim 10, wherein scheduling the plurality of execution items for execution together comprises scheduling the plurality of execution items to execute in a first time period.

17. The device of claim 16, wherein scheduling the plurality of execution items to execute in the first time period includes scheduling the plurality of execution items to each execute at least partially at the same time.

18. The device of claim 16, wherein scheduling the plurality of execution items to execute in the first time period includes scheduling the plurality of execution items to execute within a threshold amount of time.

19. A non-transitory computer-readable medium storing instructions that, when executed by a processor, cause the processor to perform operations comprising:
identifying a plurality of execution items that share data, as indicated by having matching commonality metadata;
identifying an execution unit for executing the plurality of execution items together; and
scheduling the plurality of execution items for execution together on the execution unit.

20. The non-transitory computer-readable medium of claim 19, wherein the plurality of execution items includes a first execution item having first commonality metadata and a second execution item having second commonality metadata.
